(19) United States
(12) Patent Application Publication
(10) Pub. No.: US 2015/0109663 A1
(43) Pub. Date: Apr. 23, 2015

(54) DLC Coating for an Optical IR Component and Optical IR Component Having Said DLC Coating

(71) Applicant: JENOPTIK Optical Systems GmbH, Jena (DE)

(72) Inventors: Elvira Gittler, Jena (DE); Tino Wagner, Jena (DE); Michael Degel, Jena (DE); Peter Maushake, Weimar (DE); Marcus Serwazi, Gleichen (DE)

(73) Assignee: JENOPTIK Optical Systems GmbH, Jena (DE)

(21) Appl. No.: 14/401,929

(22) PCT Filed: May 17, 2013
(86) PCT No.: PCT/DE2013/100184

§ 371 Date: Nov. 18, 2014

(30) Foreign Application Priority Data
May 18, 2012 (DE) 10 2012 010 291.7

(51) Int. Cl. G02B 1/10; G02B 1/11

(52) U.S. Cl. CPC G02B 1/105; G02B 1/11
USPC 359/359

(57) ABSTRACT

A multispectral optical IR component with a hybrid coating DLC coating and an antireflection coating. The DLC coating has at least an outer layer with a first modulus of elasticity and an inner layer with a second modulus of elasticity which are arranged one above the other on the antireflection coating. The value of the first modulus of elasticity is greater than the value of the second modulus of elasticity. There is a transmissivity to IR radiation of at least 80% over a first determined wavelength range and over a second determined wavelength range. The first determined wavelength range lies in the range of mid-wavelength IR radiation, and the second determined wavelength range lies in the range of long-wavelength IR radiation.

### RELATED APPLICATIONS

The present application is a U.S. National Stage application of International PCT Application No. PCT/DE2013/100184 filed on May 17, 2013 which claims priority benefit of German Application No. DE 10 2012 010 291.7 filed on May 18, 2012, the contents of each are incorporated by reference in their entirety.

### BACKGROUND OF THE INVENTION

The invention is directed to a DLC coating and optical IR components with a DLC coating as is known generically from U.S. Pat. No. 4,995,684 A.

Optical IR components in systems which are designed for use with infrared radiation must be able to transmit images and signals of high and consistent quality with long-term stability particularly when they are used in installations for measuring, testing or monitoring. By optical IR components is meant hereinafter all elements provided for applications in wavelength ranges of infrared radiation. Optical IR components may be, for example, optical lenses, mirrors, filters, beamsplitters, or other substrates with coatings.

In this connection, unfavorable environmental influences and influences due to operating conditions may affect the optical IR components. A particular mechanical problem occurs when the optical IR component is exposed to shock loads such as can occur for example when the optical IR component moves at high speed through rain, snow or clouds. A raindrop striking the surface of an optical IR component causes point shocks at varying locations of the surface. Further, the shocks vary in intensity and frequency. This type of mechanical stress occurs especially in optical IR components that are arranged at the front end of vehicles and aircraft.

To safeguard the optical IR components against impairment or even destruction (rain erosion), the optical IR component can be provided with a resistant protective layer.

Protective layers of this kind may comprise carbon, for example, which is applied to the optical IR component in a diamond-like structure. Protective layers of this kind are also known as hard carbon layers or diamond-like carbon layers. Therefore, the term “DLC coating” will be employed hereinafter.

DLC coatings were developed for IR components in optical systems of thermosensory monitoring installations for industrial, civil and military applications. They can be applied to materials such as silicon and germanium. Application is carried out by methods known to a person skilled in the art such as PECVD (Plasma Enhanced Chemical Vapor Deposition). In the simplest case, the refractive indices of single layers are correspondingly adapted to the refractive indices of materials of a carrier. A substrate or a layer of an antireflection coating can serve as carrier of DLC coatings.

DLC coatings are used in the IR range as single layers which are highly durable (e.g., windshield wiper test) in spectral ranges with wavelengths of 3 to 5 μm or 7 to 12 μm. DLC coatings have only limited utility with respect to spectral bandwidth, namely either in the range of mid-wavelength IR radiation (MWIR, 3-5 μm) or long-wavelength IR radiation (LWIR, 7.5-12 μm). A DLC coating is unsuited as single layer for systems operating in a broad spectral range or in dual-band systems.

### PRIOR ART

DLC coatings in which a plurality of DLC layers are arranged above an antireflection coating are known, for example, from U.S. Pat. No. 5,502,442 A. Gallium arsenide is selected as substrate. A so-called eggshell effect can easily come about when a layer of material of low elasticity (high modulus of elasticity) is arranged over layers of greater elasticity. In this case, the less elastic layers separate from the more elastic layers under shock-like stresses. This would cause the optical IR component to be destroyed or would at least greatly impair its usability to an unforeseeable extent. To prevent these negative effects, it is suggested in U.S. Pat. No. 5,502,442 A to arrange connecting layers of silicon between the layers of a DLC coating. At up to 30 μm, these silicon connection layers are sometimes very thick. While transmission values which are quite homogeneous over a wavelength range from 3 to 12 μm can be achieved with a solution of this kind, the reflection values are much too high at up to 78% for high-power optics in the IR range.

As is known, GB 2280201 A teaches that DLC coatings can be used to protect a zinc sulfide window which is transparent to IR radiation. In view of the fact that DLC coatings are transparent to IR radiation but thick DLC coatings flake easily under load (eggshell effect), GB 2280201 A suggests using a layer of germanium carbide with a thickness of up to 30 μm as a transparent intermediate layer which is covered in turn by a thin film (up to 1.5 μm) of a DLC coating. The optical characteristics of an optical IR component formed in this way are not substantially impaired by a solution of this kind. Apropos to this, the problems arising in the selection of materials of optical IR components with respect to the mechanical and optical characteristics thereof at occurring operating temperatures and mechanical stresses are discussed in the introductory part of GB 2280201 A.

To prevent a disadvantageous flaking off of the DLC coating from the more elastic layers of the substrate or of an antireflection coating, U.S. Pat. No. 4,995,684 A proposes generating a gradient of decreasing moduli of elasticity of a DLC coating through an antireflection coating to the substrate. In so doing, the selection of material of the optical IR component is made in such a way that DLC coating has a very high modulus of elasticity, a layer of the antireflection coating lying below the latter has a lower modulus of elasticity and the material of the substrate has the lowest modulus of elasticity. However, layers with a very high modulus of elasticity and layers with a lower modulus of elasticity can also be arranged in an alternating manner.

Stacking many layers of this kind on top of one another would entail a high technological expenditure. While using fewer layers limits the technological expenditure, the freedom in the choice of materials is sharply curtailed because the gradient of decreasing moduli of elasticity must be brought about. Moreover, an improved performance is sought, i.e., the usability of optical components with DLC coatings for broadband applications and minimal residual reflections and reflections.

### Object of the Invention

It is the object of the invention to provide for broadband transmission of IR radiation through an optical component in which the optical component is highly resistant to mechanical stresses.

### SUMMARY OF THE INVENTION

This object is met by a DLC coating for an optical IR component in which the DLC coating comprises at least one inner layer with a first modulus of elasticity and an outer layer with a second modulus of elasticity which are arranged one above the other on a carrier surface of a carrier, wherein the inner layer has an inner surface by which the inner layer is in direct contact with the carrier surface of the carrier, and the outer layer has an outer surface which is remote of the carrier surface. The value of the first modulus of elasticity is greater than the value of the second modulus of elasticity.

The invention includes at least one layer of the DLC coating which is resistant to mechanical influences configured such that the outer surface is protected from exposure to mechanical influence, but unattenuated transmission to the at least one layer of antireflection coating located below the outer surface is prevented. This advantageous effect is achieved by the outer surface having a higher modulus of elasticity than the layers lying below it or than the areas of the at least one layer which lie below it. Therefore, the DLC coating is less elastic at its outer surface which is directly exposed to environmental conditions than at its inner surface.

A carrier may be formed by any material on which a DLC coating can be arranged. However, the carrier is preferably a material that is transmissive to IR radiation. In further embodiments, the carrier can also comprise a material which is only slightly transmissive to or not transmissive to IR radiation (e.g., filter or mirror).

An outer surface of the DLC coating closes off the DLC coating from an environment, whereas the inner surface forms a contact surface with respect to a carrier. The end faces of the DLC coating are not considered in this description. When the prior-art DLC coating is formed as a single layer, the single layer has an outer surface and an inner surface. In a DLC coating according to the invention, the outer layer has the outer surface of the DLC coating and the inner layer has the inner surface of the DLC coating.

In one configuration of the DLC coating according to the invention, there are further layers provided between the inner layer and outer layer, the material of each of these further layers having a modulus of elasticity. The further layers are DLC layers. In this respect, the values of the moduli of elasticity of the further layers are at most equal to the value of the first modulus of elasticity. For example, the moduli of elasticity of the further layers of the DLC coating can have the same value over a plurality of layers.

In a preferred embodiment of the DLC coating according to the invention, the values of the moduli of elasticity of the further layers decrease with each layer from the outer layer to the inner layer.

In a preferred embodiment of the optical component according to the invention, the DLC coating has a gradient of decreasing values of moduli of elasticity from the outer surface thereof to the inner surface thereof, and the gradient includes at least a third modulus of elasticity having a value between the value of the first modulus of elasticity and the value of the second modulus of elasticity.

Accordingly, in a DLC coating according to the invention there is always a gradient of decreasing values of moduli of elasticity. The gradient can be a continuous decrease in the values of moduli of elasticity along the thickness of the DLC coating. However, it can also be formed by abruptly changing values of moduli of elasticity such as is commonly the case when the DLC coating is formed of multiple DLC layers with different moduli of elasticity. In further embodiments it is also possible to combine continuous decreases with abrupt decreases.

In this regard, each of the layers of the DLC coating can be given a different modulus of elasticity during application, e.g., by means of PECVD, by altering the operating parameters such that the gradient is generated along the thickness of the DLC coating.

It is extremely advantageous that the occurrence of abrupt transitions with sharply diverging elastic behavior of layers with respect to one another (expressed by moduli of elasticity) is prevented by means of an inventive configuration of the DLC coating. An occurrence of the disadvantageous eggshell effect is sharply reduced or completely prevented.

The above-stated object is further achieved in an optical IR component with a DLC coating according to the invention in which a substrate which is transmissive to IR radiation functions as carrier. The DLC coating is applied to an outer surface of the substrate. The outer surface functions as carrier surface. In a further configuration of the optical IR component, it is possible to provide an antireflection coating on an inner surface of the substrate.

In another configuration of an optical IR component according to the invention, an antireflection coating comprising at least one layer functions as carrier. The DLC coating is arranged with its inner surface on a surface of a layer of the antireflection coating that functions as carrier surface. In further embodiments, the antireflection coating can have up to 30 layers, the materials, sequence and respective thicknesses of the layers being configured in accordance with the requirements of the optical IR component.

The at least one layer of the antireflection coating is either a dielectric layer or a semiconductor layer. The antireflection coating can be formed of a plurality of layers which in turn comprise different materials.

At least one of the materials germanium, silicon, magnesium oxide, silicon oxide, silicon dioxide, zinc sulfide, zinc selenide, palladium telluride or a material from one of the material groups metal fluoride and telluride is selected for the antireflection coating. The antireflection coating may contain further materials beyond these.

It has proven advantageous when the layer of the antireflection coating which directly contacts the inner surface of the DLC coating is made of germanium. A good bonding of the DLC coating to the antireflection coating is achieved by means of germanium. The layer can also be made of or can contain doped germanium.

The antireflection coating functioning as carrier can be arranged on an outer surface of a substrate that is transmissive to IR radiation so that a further optical IR component according to the invention is provided. This construction of the optical IR component according to the invention can further be configured in such a way that an additional antireflection coating is provided on an inner surface of the substrate.

In preferred embodiments of the optical IR components according to the invention described above, germanium, silicon, zinc sulfide, zinc selenide, chalcogenide glass or sapphire is selected as material for the substrate. Other materials suitable for applications in the IR range can also be selected as material of the substrate.

To achieve desired optical and/or mechanical characteristics of the optical IR component according to the invention, a construction of the DLC coating, a construction of an antireflection coating when present, a construction of an additional antireflection coating when present, and a construction of the substrate are preferably selected based on an optimizing process. It is particularly preferred that the above-mentioned coatings and substrate be respectively constructed and adapted to one another in such a way that that there is a transmissivity to IR radiation of at least 70% over at least one determined wavelength range. The at least one determined wavelength range preferably extends from 2.7 to 11.6 μm. Other determined wavelength ranges, e.g., 3-8μm and/or >8-15 μm, can also be selected. The transmissivity is preferably at least 80% over these wavelength ranges.

A method for the construction and optimization of antireflection coatings taking into account desired optical characteristics and strain compensation between layers of different strain relationships (tensile strains and compressive strains) is known from WO 2013/041089 A1, which is hereby incorporated herein in its entirety by reference.

It is very advantageous when a first determined wavelength range and a second determined wavelength range are provided, and the first determined wavelength range lies in the range of mid-wavelength IR radiation (3-8 μm) and the second determined wavelength range lies in the range of long-wavelength IR radiation (>8-15 μm).

As a result of the construction of an optical IR component with antireflection coating and a DLC coating according to the invention, the very high resistance of a diamond coating (DLC coating) is combined with an appreciably improved transmission of a dielectric coating or a coating with semiconductor materials.

The solution according to the invention makes it possible to achieve very advantageous spectral characteristics such as high transmission (e.g., at least 80%) and low reflection (e.g., at most 2%) in at least two separate determined wavelength ranges. The determined wavelength ranges can be entirely or partially wavelength ranges of mid-wavelength IR radiation and of long-wavelength IR radiation, for example.

### BRIEF DESCRIPTION OF THE DRAWINGS

The invention will be described more fully in the following with reference to drawings and embodiment examples. The drawings show:

FIG. 1 is a construction of an optical IR component according to the prior art;

FIG. 2 is a schematic diagram showing a first embodiment example of an optical IR component according to the invention with a DLC coating;

FIG. 3 is a schematic diagram showing a second embodiment example of an optical IR component according to the invention with a DLC coating;

FIG. 4 is a schematic diagram showing a third embodiment example of an optical IR component according to the invention with a DLC coating;

FIG. 5 is a schematic representation of reflection values (percentage reflection) of an optical IR component according to the prior art compared to an optical IR component according to the invention with an additional antireflection coating on the inner surface of the substrate over wavelength (micrometers);

FIG. 6 is a schematic representation of transmission values (percentage transmission) of an optical IR component according to the prior art compared to an optical IR component according to the invention with an additional antireflection coating on the inner surface of the substrate over wavelength;

FIG. 7 is a schematic representation of transmission values of a further optical IR component according to the prior art compared to an optical IR component according to the invention with an additional antireflection coating on the inner surface of the substrate over wavelength; and

FIG. 8 is a schematic diagram showing a fourth embodiment example of an optical IR component according to the invention with a DLC coating according to the invention, an antireflection coating, a substrate and an additional antireflection coating on an inner surface of the substrate.

### DESCRIPTION OF THE EMBODIMENTS

Optical IR components 1 according to the prior art and optical components 1 according to the invention both have a substrate 2 and a DLC coating 4 as essential components. In further embodiments, they can also have an antireflection coating 3 (also referred to as AR coating 3 for the sake of brevity).

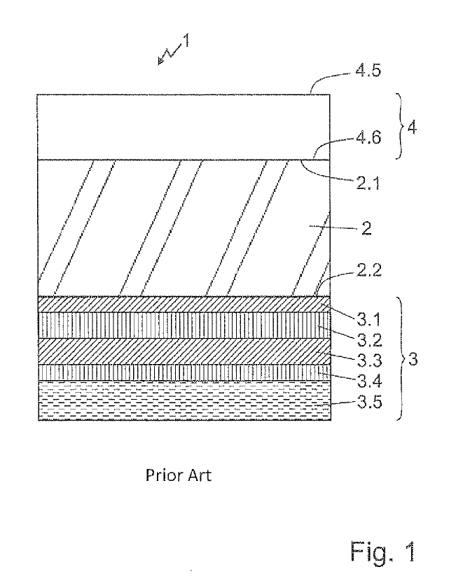

In the construction of a prior-art optical IR component 1 which is shown schematically in FIG. 1, a DLC coating 4 is arranged on an outer surface 2.1 of the substrate 2 as an individual layer. An inner surface 4.6 of the DLC coating 4 is in direct contact with the outer surface 2.1 of the substrate 2. An outer surface 4.5 of the DLC coating 4 closes off the optical IR component 1 from an environment. The outer surface 4.5 is directly exposed to active environmental influences such as rain, wind or radiation. An AR coating 3 which is formed in this instance, for example, from a sequence of a first layer 3.1 to a fifth layer 3.5 of the AR coating 3 is arranged on an inner surface 2.2 of the substrate 2. Layers 3.1 to 3.5 can have different thicknesses and can be formed of different materials in order to achieve desirable optical and mechanical characteristics as will be familiar to a person skilled in the art. The layers 3.1 to 3.5 and different materials are symbolized by different shading. The AR coating 3 is protected against direct action of environmental influences by the DLC coating 4 and by the substrate 2.

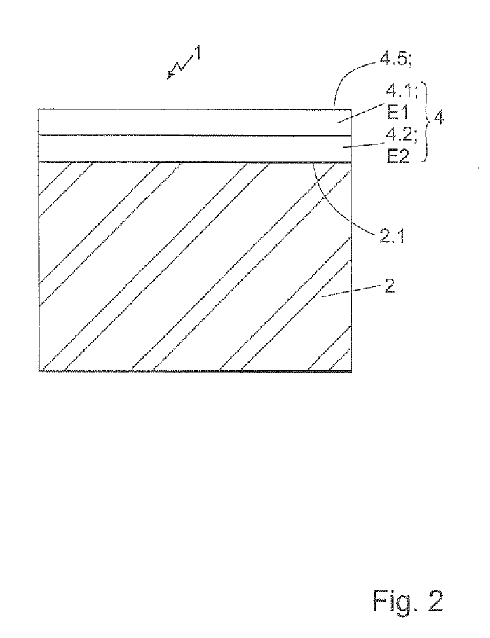

FIG. 2 shows a first embodiment example of an optical IR component 1 according to the invention with a first embodiment of a DLC coating 4 according to the invention. The DLC coating 4 comprises an outer layer 4.1 and an inner layer 4.2. The outer layer 4.1 has a first modulus of elasticity E1, and the inner layer 4.2 has a second modulus of elasticity E2. The value of the first modulus of elasticity E1 is greater than the value of the second modulus of elasticity E2. The DLC coating 4 is arranged on a carrier surface of a substrate 2 of germanium. The outer surface 4.5 of the DLC coating 4 closes off the optical IR component 1 from an environment. The substrate 2 functions as carrier, an outer surface 2.1 of the substrate 2 acts as carrier surface. The substrate 2 is transmissive to IR radiation.

In further embodiments, the substrate 2 can be made of silicon, zinc sulfide, zinc selenide, chalcogenide glass, sapphire or other materials which are transmissive to IR radiation. The substrate 2 can also be made from materials which are not transmissive to IR radiation.

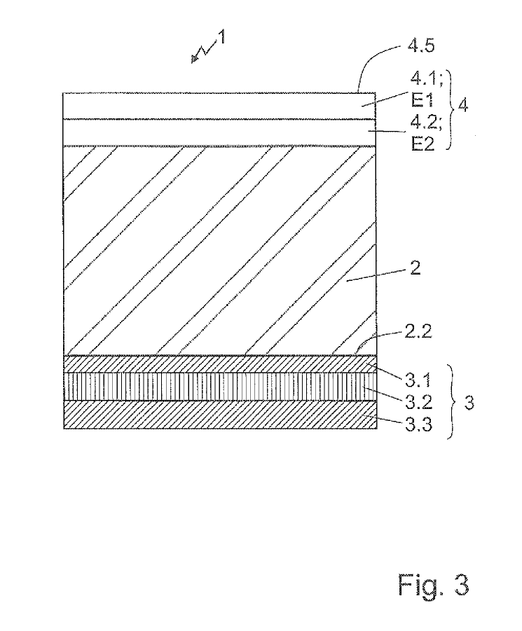

A second embodiment example of an optical IR component 1 according to the invention having the first embodiment of the DLC coating 4 according to the invention is shown in FIG. 3. The DLC coating 4 and the substrate 2 are constructed in the manner described in FIG. 2. An AR coating 3 comprising a first layer 3.1, a second layer 3.2 and a third layer 3.3 is arranged on an inner surface 2.2 of the substrate 2.

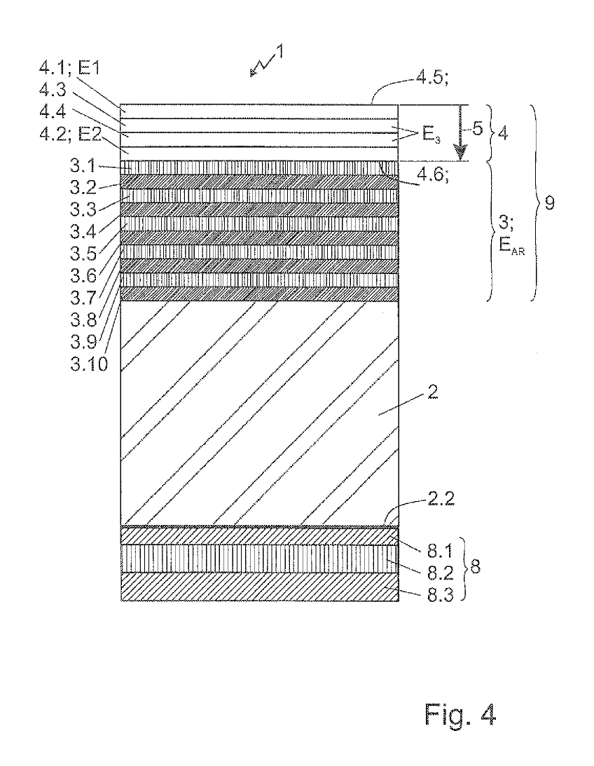

FIG. 4 shows a third embodiment example of an optical IR component 1 according to the invention. The AR coating 3 is formed by a sequence of ten layers with a first layer 3.1, a second layer 3.2, . . . up to a tenth layer 3.10. The AR coating 3 can contain layers 3.1 to 3.10 for strain compensation. The DLC coating 4 is provided above the AR coating 3 and is formed as a sequence of four layers with a first layer 4.1 (outer layer), a second layer 4.2 (inner layer) a third layer 4.3 and a fourth layer 4.4. An additional AR coating 8 comprising a first layer 8.1, a second layer 8.2 and a third layer 8.3 is provided on an inner surface 2.2 of the substrate 2.

The outer surface 4.5 closes off the optical IR component 1 from the environment. The first layer 4.1 of the DLC coating 4 has the first modulus of elasticity E1. The inner layer 4.2 is in direct contact with the first layer 3.1 of the AR coating 3 via the inner surface 4.6. The inner layer 4.2 has the second modulus of elasticity E2. Both the third layer 4.3 and fourth layer 4.4 of the DLC coating 4 have a third modulus of elasticity E3. The value of the third modulus of elasticity E3 lies between the values of the first modulus of elasticity E1 and the value of the second modulus of elasticity E2. By means of this arrangement of layers 4.1 to 4.2 and the associated values of the moduli of elasticity E1 to E3, a gradient 5 (symbolized by an arrow) of decreasing values of moduli of elasticity E1 to E3 from the outer layer 4.1 to the inner layer 4.2 is achieved. The values of the moduli of elasticity of the AR coating 3 (denoted jointly as moduli of elasticity E_{AR}) are all less than the value of the second modulus of elasticity E2. A hybrid coating 9 is provided by the AR coating 3 and the DLC coating 4 on the substrate 2.

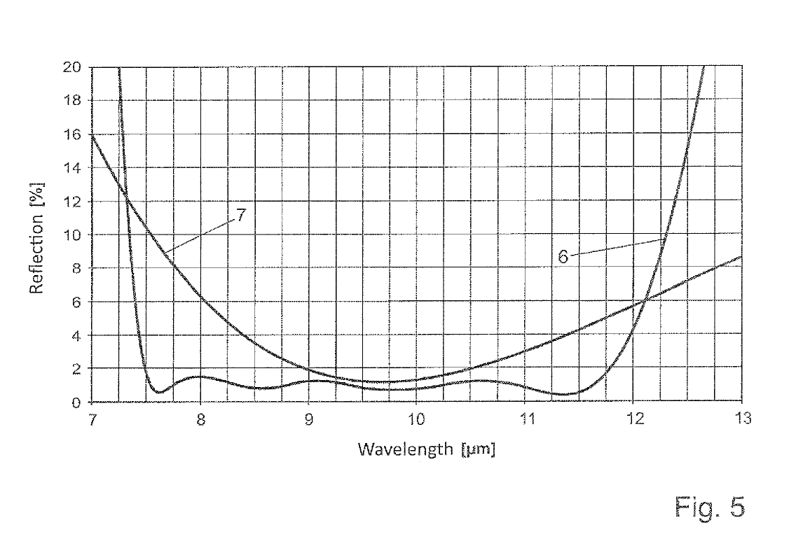

The construction according to the invention of an optical IR component 1 makes it possible to achieve very high durability of the optical IR component 1 with very low spectral residual reflection. A first curve 6 in FIG. 5 shows by way of example the reflection values (percentage) of an optical IR component 1 according to the invention with hybrid coating 9 (see FIG. 4) which were determined over a wavelength range from 7 to 13 μm. A second curve 7 illustrating the relationship of reflection values and wavelength of a conventional DLC coating 4 on a substrate in the wavelength range from 7 to 13 μm is contrasted with the first curve 6. A conventional DLC coating 4 is arranged on the substrate 2 as a single layer. It is apparent that the first curve 6 over a wavelength range from about 7.5 to 11.75 μm does not exceed the limit of two-percent reflection, while the second curve 7 shows reflection values of two percent and less only over a wavelength range from about 9 to 10.5 μm.

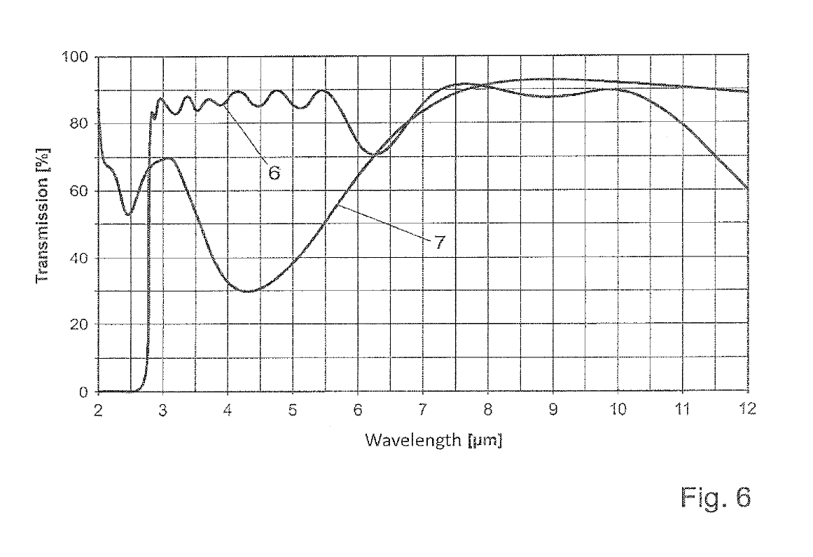

FIG. 6 shows the relationship of attainable transmission (transmissivity) (percentage) and the wavelength over a wavelength range from 2 to 12 μm. Again, determined values of an optical IR component 1 according to the invention with hybrid coating 9 are illustrated by the first curve 6 and the values of a conventional DLC coating 4 on a substrate according to the prior art are illustrated by the second curve 7. The first curve 6 shows transmission values of at least 80 percent over a wavelength range from about 2.75 μm to about 5.75 μm (MWIR) and over a wavelength range of about 6.75 μm and 10.9 μm (LWIR). The second curve 7 has transmission values of at least 80 percent only over a wavelength range from about 6.75 to 12 μm and, therefore, exclusively in the range of long-wavelength IR radiation.

The transmission values of an optical IR component 1 according to the invention which are illustrated by the first curve 6 were achieved using an optimizing process in which the materials of the layers, the thickness of the layers and the sequence of layers of the AR coating 3 and DLC coating 4 were adapted.

In further embodiment forms of the above-described optical components 1 according to the invention, the AR coating 3 and/or the additional AR coating 8 can be formed by up to 30 layers.

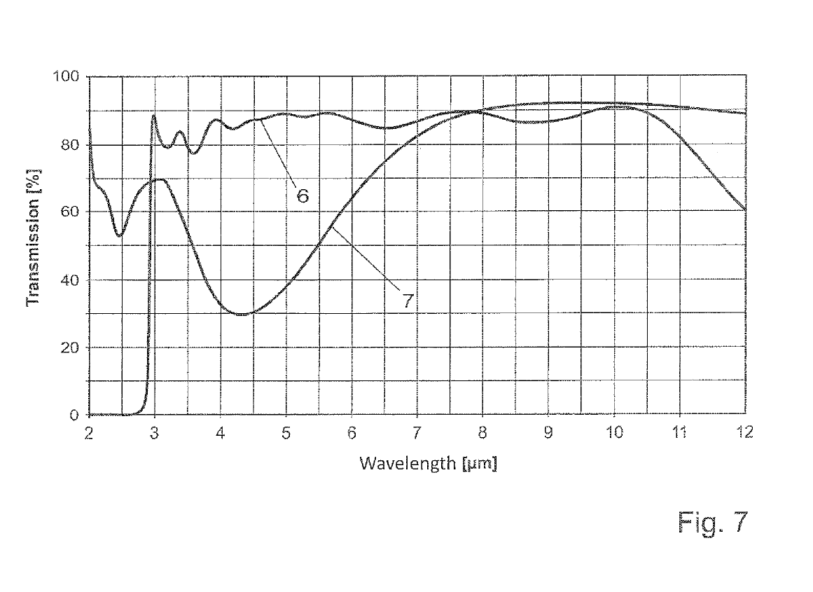

FIG. 7 shows the first curve 6 and second curve 7 of a further optical IR component 1 according to the invention (first curve 6) and a conventional optical IR component 1 (second curve 7). A conventional optical IR component 1 has a construction according to FIG. 1. The further optical IR component 1 according to the invention has the basic construction shown in FIG. 4.

The first curve 6 shows fluctuations in the transmission values of 80% over a wavelength range from about 2.9 μm to about 3.6 μm. From about 3.6 μm (MWIR) to about 11 μm (LWIR), the transmission values are above 80%. The second curve 7 has transmission values of at least 80% only over a wavelength range from about 6.9 to 12 μm and, therefore, exclusively in the range of long-wavelength IR radiation.

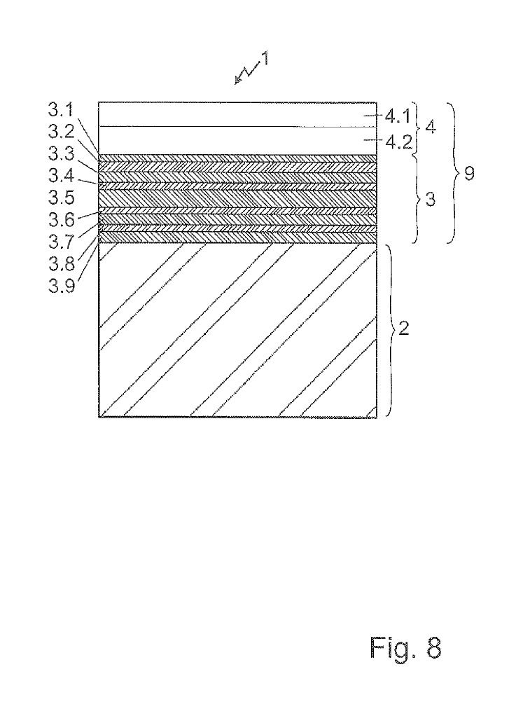

FIG. 8 shows a fourth embodiment example of an optical component 1 according to the invention. The AR coating 3 formed of a total of nine layers 3.1 to 3.9 is provided over the substrate 2 of silicon. The DLC coating 4 with the outer layer 4.1 and the inner layer 4.2 is provided over the AR coating 3. In further embodiments, the DLC coating 4 can also be formed of a plurality of layers 4.1 to 4.n. A hybrid coating 9 is formed by AR coating 3 and DLC coating 4.

In further embodiments of the optical component 1 according to the invention. different quantities of layers of the AR coating 3, DLC coating 4 and/or additional AR coating 8 can be selected.

While the invention has been illustrated and described in connection with currently preferred embodiments shown and described in detail, it is not intended to be limited to the details shown since various modifications and structural changes may he made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

### REFERENCE NUMERALS

1 optical IR component
2 substrate
2.1 outer surface (of the substrate 2)
2.2 inner surface (of substrate 2)
3 antireflection coating
3.1 first layer (of the antireflection coating 3)
3.2 second layer (of the antireflection coating 3)
3.10 tenth layer (of the antireflection coating 3)
4 DLC coating
4.1 outer layer (of the DLC coating 4)
4.2 inner layer (of the DLC coating 4)
4.3 further layer (of the DLC coating 4)
4.4 further layer (of the DLC coating 4)
4.5 outer surface
4.6 inner surface
5 gradient
6 first curve
7 second curve
8 additional antireflection coating
8.1 first layer (of the additional antireflection coating 8)
8.2 second layer (of the additional antireflection coating 8)
8.3 third layer (of the additional antireflection coating 8)
9 hybrid coating
E1 first modulus of elasticity
E2 second modulus of elasticity
E3 third modulus of elasticity
E_{AR} modulus of elasticity of the antireflection coating 3

What is claimed is:

1. Multispectral optical IR component comprising a hybrid DLC coating, said the DLC coating having at least an outer layer with a first modulus of elasticity and an inner layer with a second modulus of elasticity, said outer and inner layers being arranged one above the other on a carrier surface of a carrier, said inner layer having an inner surface by which the inner layer is in direct contact with the carrier surface of the carrier, said outer layer having an outer surface which is remote from the carrier surface, the first modulus of elasticity having a value greater than the value of the second modulus of elasticity, and an antireflection coating as carrier, said antireflection coating including at least one layer, said antireflection coating being arranged on an outer surface of a substrate that is transmissive to IR radiation, construction of the DLC coating, of the antireflection coating and of the substrate being selected based on an optimizing process such that there is a transmissivity to IR radiation of at least 80% over a first determined wavelength range and over a second determined wavelength range, and the first determined wavelength range lying in the range of mid-wavelength IR radiation, and the second determined wavelength range lying in the range of long-wavelength IR radiation.

2. The optical IR component according to claim 1, wherein said first determined wavelength range is 2.75 μm to 5.75 μm and the second determined wavelength range is 6.75 μm to 10.9 μm.

3. The optical IR component according to claim 1, further comprising further layers which each have a modulus of elasticity between the inner layer and outer layer, wherein the values of the moduli of elasticity of the further layers are at most equal to the value of the first modulus of elasticity.

4. The optical IR component according to claim 3, wherein the values of all of the moduli of elasticity decrease with each layer from the outer layer to the inner layer.

4. (canceled)

5. (canceled)

5. The optical IR component according to claim 1, wherein the at least one layer of the antireflection coating is either a dielectric layer or a semiconductor layer.

6. The optical IR component according to claim 1, wherein at least one of the materials germanium, silicon, magnesium oxide, silicon oxide, silicon dioxide, zinc sulfide, zinc selenide, palladium telluride or a material from one of the material groups metal fluoride and telluride is selected as material for the antireflection coating.

7. The optical IR component according to claim 6, characterized in that the layer of the antireflection coating directly contacting the inner surface of the DLC coating is made of germanium.

8. The optical IR component according to claim 1, wherein germanium, silicon, zinc sulfide, zinc selenide, chalcogenide glass or sapphire is selected as material for the substrate.

10. (canceled)

9. The optical IR component according to claim 1, further comprising an additional antireflection coating is provided on an inner surface of the substrate.

10. The optical IR component according to claim 1, wherein a construction of the DLC coating, of the antireflection coating, of an additional antireflection coating when present, and of the substrate is selected based on an optimizing process such that there is a transmissivity to IR radiation of at least 70% over a determined wavelength range from 2.7 μm to 11.6 μm.

13. (canceled)

14. (canceled)
